(19) United States
(12) Patent Application Publication
(10) Pub. No.: US 2020/0289357 A1
(43) Pub. Date: Sep. 17, 2020

(54) ASSIST APPARATUS

(71) Applicant: JTEKT CORPORATION, Osaka-shi (JP)

(72) Inventors: Hisataka SATO, Toyota-shi (JP); Tomoki ARAI, Kitakatsuragi-gun (JP); Shinji TAKEUCHI, Okazaki-shi (JP)

(73) Assignee: JTEKT CORPORATION, Osaka-shi (JP)

(21) Appl. No.: 16/808,447

(22) Filed: Mar. 4, 2020

(30) Foreign Application Priority Data
Mar. 11, 2019 (JP) 2019-043462
Mar. 11, 2019 (JP) 2019-043463
Mar. 11, 2019 (JP) 2019-043464

(51) Int. Cl. A61H 3/00; A61H 1/02

(52) U.S. Cl. CPC A61H 3/00; A61H 1/0281; A61H 2003/007; A61H 2205/102; A61H 2201/164; A61H 2201/1207; A61H 2201/1628; A61H 2201/1671; A61H 2201/1652; A61H 2201/5064

(57) ABSTRACT

An assist apparatus includes: a shoulder harness; an actuator; a power transmission member connected to the actuator; a pulley support portion; a leg-side pulley; a knees-linking member; a left knee harness to be fitted to a left knee region of the wearer, the left knee harness being connected to a first end of the knees-linking member; a right knee harness to be fitted to a right knee region of the wearer, the right knee harness being connected to a second end of the knees-linking member; a posture detection device that detects a posture of the wearer; and a control device that controls the actuator based on information of the posture of the wearer, the posture being detected by the posture detection device.

### CROSS-REFERENCE TO RELATED APPLICATIONS

This application claims priority to Japanese Patent Application No. 2019-043462 filed on Mar. 11, 2019, Japanese Patent Application No. 2019-043463 filed on Mar. 11, 2019, and Japanese Patent Application No. 2019-043464 filed on Mar. 11, 2019, each incorporated herein by reference in its entirety.

### BACKGROUND

### 1. Technical Field

The present disclosure relates to an assist apparatus that assists work in a state of being worn on a human body.

### 2. Description of Related Art

Various assist apparatuses that assist work in a state of being worn on a human body have been proposed. For example, Japanese Patent Application Publication No. 2003-265548 (JP 2003-265548 A) describes a wearable boost apparatus including a wire wind-up drum, which serves as a drive section, in a drive section fitting mechanism to be detachably fitted to the hip region of a user. A boost transmission mechanism to be detachably fitted to the upper part of the user's body is pivotally attached above the drive section fitting mechanism so as to be pivotable in a front-rear direction. A reaction force reception mechanism that operates in coordination with movement of the legs of the user is provided below the drive section fitting mechanism. A boost transmission wire is provided in a tense state between the drive section of the drive section fitting mechanism and the boost transmission mechanism and a tension transmission wire is provided in a tense state between the drive section fitting mechanism and the reaction force reception mechanism.

### SUMMARY

The wearable boost apparatus described in JP 2003-265548 A enables, when the user lifts a heavy load with the wearable boost apparatus worn on the body, performing the lifting work efficiently with a small burden. Also, the wearable boost apparatus prevents a large load from being imposed on the lower back of the user and thus enables reduction of the risk of injuring the back. However, the boost transmission mechanism includes, e.g., a pair of interlocking rods for transmitting an auxiliary force to the part from the waist to the shoulders of the upper half of the body, each of the pair of interlocking rods being made of a hollow steel pipe, and a tilting rod made of a stainless steel tube, the tilting rod extending upward and being disposed between the pair of interlocking rods. Also, the reaction force reception mechanism provided on the legs includes, e.g., a pair of extendable connection rods detachably disposed on the right and left legs.

As stated above, in the wearable boost apparatus described in JP 2003-265548 A, the assist force transmission mechanisms include rigid body components such as various types of rods and thus are poor in capability of following movement of the wearer and are very heavy, causing difficulty in reducing the operator's burden. Also, because of including rigid body components such as various types of rods, the assist force transmission mechanisms have difficulty in responding to variations in physical size of wearers. In addition, positions of, e.g., each of joints in the wearable boost apparatus are easily displaced from ideal positions for the wearer, which may cause discomfort in wearing, and in addition, may cause a decrease in assist force transmission efficiency. Furthermore, when the wearer travels to a work site at which the wearer performs the work of, e.g., lifting and lowering packages, on foot, if no assist force is generated, the wearer cannot easily walk because of resistance of the actuator being imposed.

The present disclosure provides an assist apparatus that is light, properly absorbs a difference in physical size between wearers to curb a decrease in assist force transmission efficiency, is highly capable of following movement of a wearer, and during a walking motion, enables the wearer to walk easily without generating an assist force.

An aspect of the present disclosure provides an assist apparatus. The assist apparatus includes: a shoulder harness to be fitted to the right and left shoulder regions of a wearer; an actuator provided in the shoulder harness; a power transmission member connected to the actuator; a pulley support portion that receives a force transmitted from the power transmission member, is to be disposed within a region from the shoulder regions to a waist region on the back side of the wearer, and supports a leg-side pulley, the leg-side pulley being a pulley to be disposed below the pulley support portion within the region from the shoulder regions to the waist region of the wearer; a knees-linking member that is an elongated member looped around the leg-side pulley; a left knee harness to be fitted to the left knee region of the wearer, the left knee harness being connected to a first end of the knees-linking member; a right knee harness to be fitted to the right knee region of the wearer, the right knee harness being connected to a second end of the knees-linking member; a posture detection device that detects a posture of the wearer; and a control device that controls the actuator based on information of the posture of the wearer, the posture being detected by the posture detection device.

With the above configuration, since the shoulder harness, the left knee harness and the right knee harness to be fitted to the wearer are separated from one another, the assist apparatus is light and is highly capable of following movement of the wearer. Also, the wearer only needs to fit the shoulder harness to the right and left shoulder regions, the waist harness to the waist region, the left knee harness to the left knee region, and the right knee harness to the right knee region (the shoulder harness, the left knee harness and the right knee harness are separated from one another). Consequently, irrespective of differences in physical size, each of wearers can fit the respective members to respective proper positions on the wearer's body, enabling curbing a decrease in assist force transmission efficiency. Also, the left knee harness and the right knee harness are linked via the knees-linking member (for example, a belt or a cable for power transmission), and when the walker walks, the knees-linking member looped around the leg-side pulley just moves forward and backward with almost no operation of the actuator (for example, an electric motor). Therefore, during a walking motion, the wearer can walk easily without generating an assist force.

In the assist apparatus, a first end of the power transmission member may be connected to the actuator. A second end of the power transmission member may be connected to the shoulder harness via a length adjustment device. The length adjustment device may be provided in the shoulder harness and may be capable of being set to one of a released state and a locked state. The released state may be a state in which winding and unwinding of the power transmission member are possible and the locked state may be a state in which winding and unwinding of the power transmission member are prohibited.

With the above configuration, the length adjustment device enables a length of the power transmission member when the wearer wears the assist apparatus to be adjusted according to the physical size of the wearer, which is convenient.

The assist apparatus may further include a left hip harness to be fitted to a left hip region of the wearer, and a right hip harness to be fitted to a right hip region of the wearer. A left guide portion that enables the knees-linking member to be inserted through the left guide portion and guides the knees-linking member from the leg-side pulley toward the left knee harness may be provided in the left hip harness. A right guide portion that enables the knees-linking member to be inserted through the right guide portion and guides the knees-linking member from the leg-side pulley toward the right knee harness may be provided in the right hip harness.

With the above configuration, inclusion of the left hip harness provided with the left guide portion that guides the knees-linking member from the leg-side pulley toward the left knee harness and the right hip harness provided with the right guide portion that guides the knees-linking member from the leg-side pulley toward the right knee harness enables curbing a decrease in assist force transmission efficiency.

In the assist apparatus, the power transmission member may be either one of a first belt having a first predetermined width and a first cable having a first predetermined diameter, and the knees-linking member may be either one of a second belt having a second predetermined width and a second cable having a second predetermined diameter.

With the above configuration, use of the first belt or the first cable as the power transmission member and use of the second belt or the second cable as the knees-linking member enable easily and properly providing the power transmission member and the knees-linking member.

In the assist apparatus, the knees-linking member may be a second belt having a second predetermined width and a leg-side pulley rotation axis that is a rotation axis of the leg-side pulley may be set in a right-left direction of the wearer.

With the above configuration, the second belt is used as the knees-linking member and the leg-side pulley rotation axis is set in the right-left direction of a wearer to, when the second belt comes into contact with the wearer's body, make a belt surface come into contact with the wearer's body. In other words, in comparison with the case where the leg-side pulley rotation axis is set in a front-rear direction of the wearer, the area of contact when the second belt comes into contact with the wearer can be made larger.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a back view illustrating an example configuration of an assist apparatus according to a first embodiment;

FIG. 2 is a back view illustrating an example of a wearer wearing the assist apparatus according to the first embodiment;

FIG. 3 is a left side view illustrating an example of a wearer wearing the assist apparatus according to the first embodiment;

FIG. 4 is a perspective view illustrating assist operations of the assist apparatus according to the first embodiment when a wearer has a stooped posture;

FIG. 5 is a block diagram illustrating a control configuration of the assist apparatus;

FIG. 6 is a flowchart illustrating “assist processing” performed by a control device of the assist apparatus;

FIG. 7 is a diagram illustrating lifting work of a wearer;

FIG. 8 is a diagram illustrating change in a forward-tilting angle and a lifting assist torque of a stepping motor over time when a wearer performs lifting work;

FIG. 9 is a diagram illustrating lowering work of a wearer;

FIG. 10 is a diagram illustrating change in a forward-tilting angle and a lowering assist torque of a stepping motor over time when a wearer performs lowering work;

FIG. 11 is a perspective view illustrating an example configuration of an assist apparatus according to a second embodiment;

FIG. 12 is a back view illustrating an example configuration of an assist apparatus according to the third embodiment;

FIG. 13 is a back view illustrating an example of a wearer wearing the assist apparatus according to the third embodiment;

FIG. 14 is a left side view illustrating an example of a wearer wearing the assist apparatus according to the third embodiment;

FIG. 15 is a perspective view illustrating assist operations of the assist apparatus according to the third embodiment when a wearer has a stooped posture; and

FIG. 16 is a perspective view illustrating an example configuration of an assist apparatus according to a fourth embodiment.

### DETAILED DESCRIPTION OF EMBODIMENTS

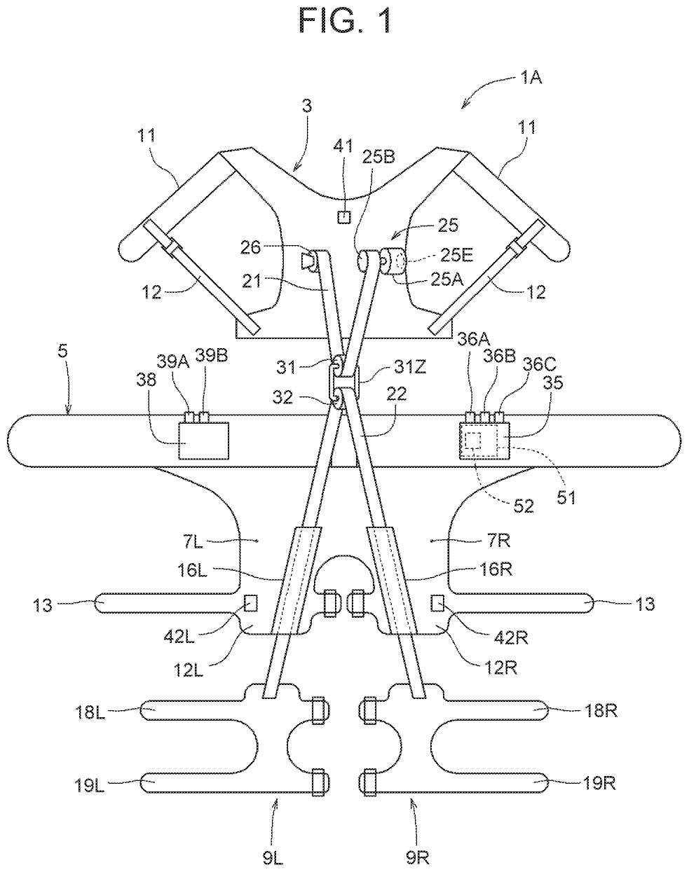

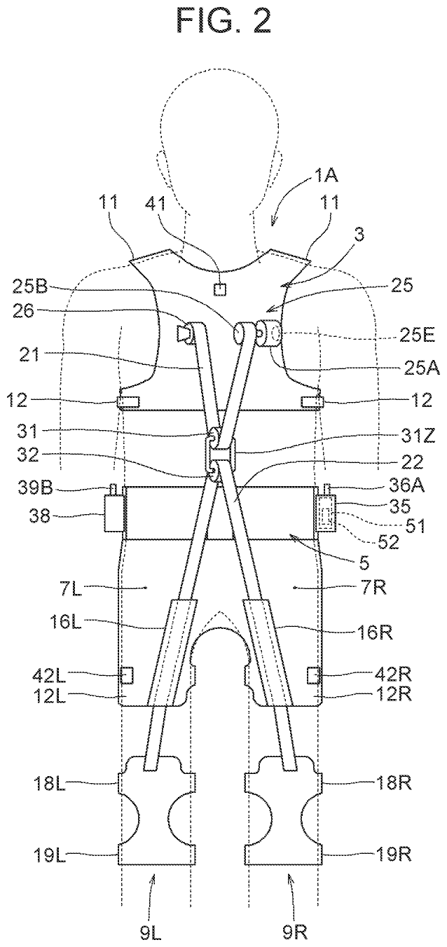

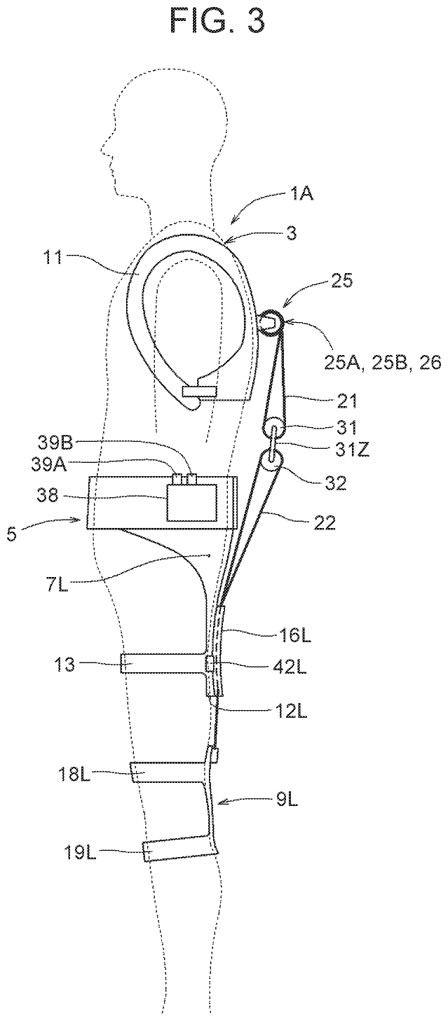

First to fourth embodiments, each of which is an embodiment of an assist apparatus according to the present disclosure, will be described in detail below with reference to the drawings. First, a schematic configuration of an assist apparatus 1A according to a first embodiment will be described based on FIGS. 1 to 5.

As illustrated in FIGS. 1 to 4, an assist apparatus 1A includes, e.g., a shoulder harness 3 to be fitted to the upper back region and right and left shoulder regions of a wearer, a belt-like waist harness 5 to be fitted to the waist region of the wearer, a right hip harness 7R to be fitted to the right hip region of the wearer, a left hip harness 7L to be fitted to the left hip region of the wearer, a right knee harness 9R to be fitted to the right knee region, including a region below the right knee, of the wearer and a left knee harness 9L to be fitted to the left knee region, including a region below the left knee, of the wearer. The shoulder harness 3, the waist harness 5, the right hip harness 7R, the left hip harness 7L, the right knee harness 9R and the left knee harness 9L are each formed of, e.g., fabric having a certain degree of flexibility.

A pair of shoulder belts 11 and a pair of armpit belts 12 for fixing the shoulder harness 3 to the right and left shoulder regions of the wearer are provided in the shoulder harness 3. Also, an electric motor 25A and a motor pulley 25B included in an actuator 25, and a transmission member length adjustment device 26, etc., are provided in the shoulder harness 3. The shoulder belts 11 and the armpit belts 12 can be adjusted in length via locking members such as belts and buckles or hook-and-loop fasteners and can be adjusted in degree of fitting of the shoulder harness 3 to the wearer. The shoulder harness 3 is fitted to the right and left shoulder regions of the wearer and is deformable along the body shape of the wearer.

In the belt-like waist harness 5, e.g., a power supply unit 38 that supplies electric power to the electric motor 25A and devices inside a control box 35, and the control box 35 that receives, e.g., a motor driver circuit and a control device are provided.

The waist harness 5 is fitted to the waist region of the wearer and is deformable along the body shape of the wearer.

Also, the right hip harness 7R to be fitted to the right hip region of the wearer and the left hip harness 7L to be fitted to the left hip region of the wearer are joined to a lower edge of the waist harness 5. The right hip harness 7R and the left hip harness 7L are formed of, for example, a member that is more stretchable than the shoulder harness 3. Also, a right thigh fixing portion 12R to be fixed to the upper part of the right thigh is provided at a lower end of the right hip harness 7R and a left thigh fixing portion 12L to be fixed to the upper part of the left thigh is provided at a lower end of the left hip harness 7L. Also, a belt 13 for fastening and fixing the right hip harness 7R around the upper part of the right thigh of the wearer is provided on the lower side of the right hip harness 7R and a belt 13 for fastening and fixing the left hip harness 7L to the upper part of the left thigh of the wearer is provided on the lower side of the left hip harness 7L. The left hip harness 7L is fitted to the left hip region of the wearer and is deformable along the body shape of the wearer and the right hip harness 7R is fitted to the right hip region of the wearer and is deformable along the body shape of the wearer.

A right guide portion 16R that allows a knees-linking member 22 to be inserted therethrough and guides the knees-linking member 22 from a leg-side pulley 32 toward the right knee harness 9R is provided in the right hip harness 7R. Likewise, a left guide portion 16L that allows the knees-linking member 22 to be inserted therethrough and guides the knees-linking member 22 from the leg-side pulley 32 toward the left knee harness 9L is provided in the left hip harness 7L. The right guide portion 16R and the left guide portion 16L are each formed in a tubular shape that is vertically long in front view, by sewing fabric having a rectangular shape that is substantially vertically long in front view in the vertical direction. Also, the right guide portion 16R and the left guide portion 16L are each formed of, for example, a member that is more stretchable than the shoulder harness 3.

Each of the waist harness 5 and the belts 13 can be adjusted in length via a locking member such as a belt and a buckle or a hook-and-loop fastener, and the degree of fitting of each of the waist harness 5, the right hip harness 7R and the left hip harness 7L to the wearer is adjustable. Therefore, when the wearer makes a stooping motion with the left thigh fixing portion 12L and the right thigh fixing portion 12R fixed via the respective belts 13, the right hip harness 7R and the left hip harness 7L, and the right guide portion 16R and the left guide portion 16L smoothly expand and contract along the right and left thigh regions because of each being formed of a highly stretchable member.

The left knee harness 9L and the right knee harness 9R are each formed of, e.g., fabric having a certain degree of flexibility, form a shape that is symmetrical in a right-left direction and are disposed on the back sides of the left knee and the right knee, respectively. An upper belt 18L to be fastened and fixed around a region above the left knee and a lower belt 19L to be fastened and fixed around the region below the left knee are provided in the left knee harness 9L. An upper belt 18R to be fastened and fixed around a region above the right knee and a lower belt 19R to be fastened and fixed around the region below the right knee are provided in the right knee harness 9R. The left knee harness 9L is connected to one end of the knees-linking member 22, is fitted to the left knee region, including the region below the left knee, of the wearer and is deformable along the body shape of the wearer. Likewise, the right knee harness 9R is connected to another end of the knees-linking member 22, is fitted to the right knee region, including the region below the right knee, of the wearer and is deformable along the body shape of the wearer. Note that in the left knee harness 9L and the right knee harness 9R, the lower belts 19L, 19R are essential but the upper belts 18L, 18R may be omitted.

Fitting the left knee harness 9L and the right knee harness 9R to the region below the left knee in the left knee region and the region below the right knee in the right knee region of the wearer, respectively, is more preferable because an effect of curbing displacement caused by a force of being pulled from above is exerted by the respective protruding parts around the patellae (kneecaps) of the knees. As described above, the left knee harness 9L and the right knee harness 9R are fitted to the knee regions of the wearer, and here, the “knee region” is a region around the left knee or the right knee of the wearer, the region including regions above and below the relevant knee and enabling the relevant knee to be stably held without displacement (the region partly including the thigh region and the shin).

Each of the upper belts 18L, 18R and the lower belts 19L, 19R is adjustable in length via a locking member such as a belt and a buckle or a hook-and-loop fastener and the respective degrees of fitting of the left knee harness 9L and the right knee harness 9R to the wearer are adjustable. Therefore, the upper belts 18L, 18R and the lower belts 19L, 19R are fastened and fixed around the regions above the left knee and the right knee and the regions below the left knee and the right knee, respectively, preventing hindering the wearer from making a stooping motion and a walking motion.

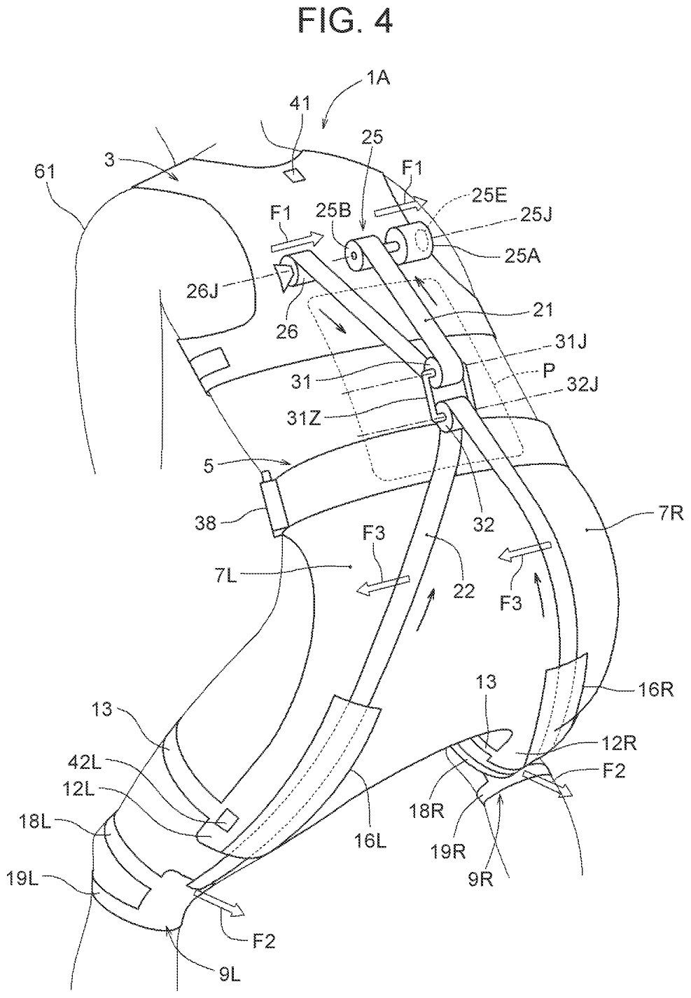

Since the upper belts 18L, 18R and the lower belts 19L, 19R are fastened and fixed around the regions above the left knee and the right knee and the regions below the left knee and the right knee, respectively, as described later, during a stooping motion of the wearer, when an upward pulling force is applied to the knees-linking member 22 with the one end and the other end connected to the left knee harness 9L and the right knee harness 9R, respectively (see FIG. 4), upward displacement of the left knee harness 9L and the right knee harness 9R can effectively be curbed.

The actuator 25 includes, e.g., the electric motor 25A and the motor pulley 25B. The actuator 25 is provided in the shoulder harness 3 or the waist harness 5; and the present embodiment indicates an example in which the actuator 25 is provided in the shoulder harness 3. Also, the other end side (or the one end side) of a power transmission member 21 is connected to the motor pulley 25B. The one end side (or the other end side) of the power transmission member 21 is connected to the transmission member length adjustment device 26. Note that either of the end portions of the power transmission member 21 may be “one end”. The electric motor 25A is driven by a control signal from a control device 52 to wind or unwind the power transmission member 21. Also, rotation detection means 25E (for example, a rotary encoder) is provided in the electric motor 25A and the rotation detection means 25E outputs a detection signal according to rotation of the electric motor 25A to the control device 52. Note that the rotation detection means 25E is not limited to a rotary encoder and may be any of various rotational angle detectors (rotation number detection device) including a Hall element, a Hall IC, a potentiometer and a resolver. Also, as illustrated in FIG. 4, an electric motor rotation axis 25J, which is a rotation axis of the electric motor 25A, is set in the right-left direction of the wearer and a length adjustment device rotation axis 26J, which is a rotation axis of the transmission member length adjustment device 26, is set in the right-left direction of the wearer. Note that the actuator 25 does not need to be a winding device that performs winding and unwinding and may be an actuator that makes a linear motion.

The power transmission member 21 is a first belt having a first predetermined width or a first cable having a first predetermined diameter; the present embodiment indicates an example in which the power transmission member 21 is the first belt. The power transmission member 21 is a bendable elongated member made of, for example fabric, and includes the one end connected to the transmission member length adjustment device 26 attached to the shoulder harness 3 and the other end connected to the motor pulley 25B. Note that the transmission member length adjustment device 26 may be omitted and the one end of the power transmission member 21 may be fixed to the shoulder harness 3. The power transmission member 21 bending so as to sag down is looped around a back torso-side pulley 31.

The transmission member length adjustment device 26 is provided in the shoulder harness 3 and the one end of the power transmission member 21 is connected to the transmission member length adjustment device 26. The transmission member length adjustment device 26 can be set to either one of a released state in which winding and unwinding of the connected power transmission member 21 are possible and a locked state in which winding and unwinding of the connected power transmission member 21 are prohibited, enables a length of the power transmission member 21 (for example, a length of the sagging U-shape portion) to be adjusted according to the body shape of the wearer and thus enables optimum (effective) transmission of an assist force.

The back torso-side pulley 31 provided in a pulley support portion 31Z is a moving pulley, the power transmission member 21 bending so as to sag down is looped around the back torso-side pulley 31 and the back torso-side pulley 31 is disposed within the region from the shoulder region to the waist region on the back side of the wearer. Note that a diameter of the back torso-side pulley 31 is set to be a proper value as well as an assist target torque, an output torque of the electric motor 25A, a diameter of the motor pulley 25B and a diameter of the leg-side pulley 32. Note that, as illustrated in FIG. 4, a back torso-side pulley rotation axis 31J, which is a rotation axis of the back torso-side pulley 31, (or a center axis (31J) of a part of the pulley support portion 31Z, the part corresponding to the position of the back torso-side pulley 31), is set in the right-left direction of the wearer. Consequently, even if the power transmission member 21 comes into contact with the wearer, the area of the contact between the wearer and the power transmission member 21 can be made larger in comparison with the case where the back torso-side pulley rotation axis 31J is set in a front-rear direction of the wearer. The leg-side pulley 32 is connected to the back torso-side pulley 31 via the pulley support portion 31Z. Note that the back torso-side pulley 31 may be omitted and the part of the pulley support portion 31Z, the part corresponding to the position of the back torso-side pulley 31, may be replaced with a non-rotating columnar portion (columnar portion including a smooth outer circumferential surface and having a diameter corresponding to the diameter of the back torso-side pulley), and where the back torso-side pulley 31 is omitted, (the columnar portion of) the pulley support portion 31Z corresponds to the moving pulley.

Then, the power transmission member 21 transmits (adjusts) power (a winding force, an unwinding force or a tensional force) of the actuator 25 to move the back torso-side pulley 31, the pulley support portion 31Z and the leg-side pulley 32 upward or downward. In other words, the power of the actuator 25 is transmitted to the power transmission member 21 to move the back torso-side pulley 31, the pulley support portion 31Z and the leg-side pulley 32 upward or downward. Then, the force of upward or downward movement transmitted to the leg-side pulley 32 (force between the back torso region and the leg region) acts on the leg side (knee region) via the knees-linking member 22. Note that the power transmission member 21 does not necessarily need to be a belt. For example, the power transmission member 21 may be a linear member that moves upward and downward, the linear member supporting the rotation shaft portion (pulley support portion 31Z) of the leg-side pulley 32 so as to move the leg-side pulley 32 upward and downward, being connected to an output of the actuator 25, and being formed of, e.g., flexible resin or metal (that is flexed according to the body shape of the wearer).

The leg-side pulley 32 is a pulley and is connected (joined) to the back torso-side pulley 31 via the pulley support portion 31Z. The leg-side pulley 32 is disposed below the back torso-side pulley 31 within the region from the shoulder region to the waist region of the wearer. The knees-linking member 22 is looped around the leg-side pulley 32. Also, a leg-side pulley rotation axis 32J, which is a rotation axis of the leg-side pulley 32, is set in the right-left direction of the wearer. Consequently, even if the knees-linking member 22 comes into contact with the wearer, the area of the contact between the wearer and the knees-linking member 22 can be made larger in comparison with the case where the leg-side pulley rotation axis 32J is set in the front-rear direction of the wearer.

The knees-linking member 22 is a second belt having a second predetermined width or a second cable having a second predetermined diameter; the present embodiment indicates an example in which the knees-linking member 22 is the second belt. The knees-linking member 22 is a bendable elongated member made of, for example, fabric. The one end side of the knees-linking member 22 is connected to the left knee harness 9L through the left guide portion 16L provided in the left hip harness 7L. The other end side of the knees-linking member 22 is connected to the right knee harness 9R through the right guide portion 16R provided in the right hip harness 7R. A part around a center in a longitudinal direction of the knees-linking member 22 is looped around the leg-side pulley 32. Note that length adjustment means for enabling adjustment of a length of the knees-linking member 22 from the left knee harness 9L to the right knee harness 9R is provided in each of a part of connection between the knees-linking member 22 and the left knee harness 9L and a part of connection between the knees-linking member 22 and the right knee harness 9R.

Since the left knee harness 9L and the right knee harness 9R are connected to the one end and the other end of the single knees-linking member 22, respectively, when the wearer walks, the wearer can easily walk. More specifically, during walking, when the wearer swings the right leg forward and the left leg rearward, the knees-linking member 22 is pulled up from the left leg side and is pulled out to the right leg side as viewed from the leg-side pulley 32. When the wearer swings the right leg rearward and the left leg forward, the knees-linking member 22 is pulled up from the right leg side and pulled out to the left leg side as viewed from the leg-side pulley 32. In other words, when the wearer walks, the knees-linking member 22 looped around the leg-side pulley 32 just moves back and forth between the left leg side and the right leg side, and thus, the wearer can walk with almost no actuation of the actuator 25. Therefore, the wearer can walk easily (in this case, the leg-side pulley 32 operates like a fixed pulley).

The control box 35 is provided, for example, on an outer surface of a part of the waist harness 5, the part corresponding to the right waist region of the wearer. The control box 35 is a substantially rectangular parallelepiped box body that receives, e.g., a control unit 51 that controls driving of the electric motor 25A, etc. For example, a main switch 36A, a lifting assist switch 36B and a lowering assist switch 36C are disposed at an upper end surface of the control box 35. Each time the main switch 36A is pressed, the main switch 36A alternately outputs either one of an activation signal and a halt signal to the control unit 51, that is, the main switch 36A is an on-off switch of the control unit 51. The lifting assist switch 36B, upon being pressed, outputs an ON signal for performing a lifting assist operation to the control unit 51. The lowering assist switch 36C, upon being pressed, outputs an ON signal for performing a lowering assist operation to the control unit 51.

The power supply unit 38 is provided, for example, on an outer surface of a part of the waist harness 5, the part corresponding to the left waist region of the wearer. The power supply unit 38 is a substantially rectangular parallelepiped box body that supplies electric power to the control box 35 and the electric motor 25A. The power supply unit 38 receives a battery (for example, a lithium ion battery). For example, an ON switch 39A and an OFF switch 39B are disposed at an upper end surface of the power supply unit 38. Upon the wearer pressing the ON switch 39A, an electric power supply start signal is output to the power supply unit 38, and supply of electric power to the control box 35 and the electric motor 25A is thus started. Upon the wearer pressing the OFF switch 39B, an electric power shut-off signal is output to the power supply unit 38, and the supply of electric power to the power control box 35 and the electric motor 25A is shut off.

A back triaxial acceleration and angular velocity sensor 41 is a posture detection device that detects a posture of the wearer, and is provided, for example, in a part, in a center in the right-left direction, of an outer surface of the shoulder harness 3, the part corresponding to the upper side of the back region of the wearer. Also, a left-leg triaxial acceleration and angular velocity sensor 42L is a posture detection device that detects a posture of the wearer, and is provided, for example, in a part of an outer surface of the left hip harness 7L, the part corresponding to a position in the vicinity of a proximal end portion of the belt 13. Also, the right-leg triaxial acceleration and angular velocity sensor 42R is a posture detection device that detects a posture of the wearer, and is disposed, for example, in a part of an outer surface of the right hip harness 7R, the part corresponding to a position in the vicinity of a proximal end portion of the belt 13.

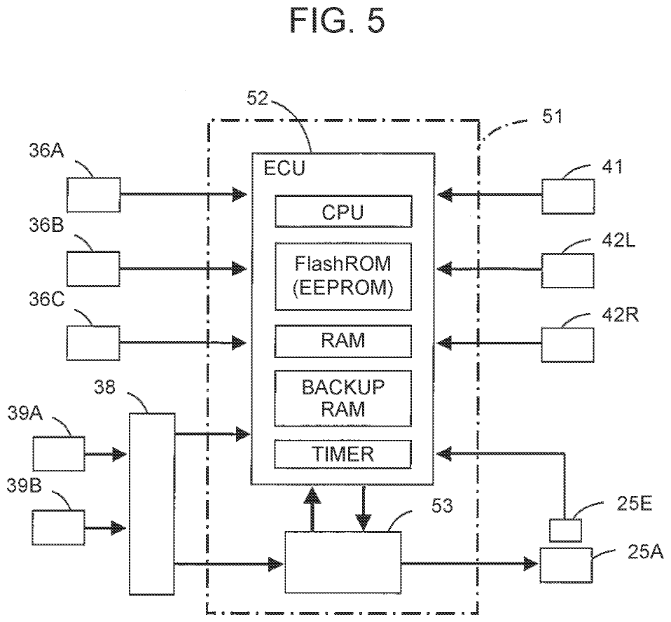

For each of three direction axes, X-axis, Y-axis and Z-axis, each of the triaxial acceleration and angular velocity sensors 41, 42L, 42R measures an acceleration and an angular velocity of rotation around the axis. Then, each of the triaxial acceleration and angular velocity sensors 41, 42L, 42R outputs, for example, a detection signal according to an inclination in each of the three directions, the X-axis, the Y-axis and the Z-axis, to the control device 52 (see FIG. 5). Note that the Z-axis direction is the vertical direction; the X-axis direction is the right-left direction of the wearer and the Y-axis direction is the front-rear direction of the wearer.

Here, an example in which when a wearer 61 wearing the assist apparatus 1A configured as described above has a stooped posture, the electric motor 25A is driven to rotate (normally) in a direction in which the power transmission member 21 is wound will be described with reference to FIG. 4.

As illustrated in FIG. 4, when the wearer 61 wearing the assist apparatus 1A has a stooped posture, upon the electric motor 25A being driven to rotate (normally) and winding the power transmission member 21, a rearward acting force F1 is generated as a result of a downward pulling force from the power transmission member 21 acting on the opposite end portions (in this case, the motor pulley 25B and the transmission member length adjustment device 26) of the power transmission member 21. In other words, the acting force F1 is generated to make the upper half of the wearer's body having a stooped posture rise.

Also, upon the power transmission member 21 being wound, the back torso-side pulley 31 and the leg-side pulley 32 are pulled upward. Note that the back torso-side pulley 31 is a moving pulley that moves relative to the power transmission member 21 and the electric motor 25A can pull the back torso-side pulley 31 and the leg-side pulley 32 up with smaller torque. The output torque of the electric motor 25A may be half of a required torque, which is an assist force. Therefore, the electric motor 25A can be made smaller and lighter.

Upon the leg-side pulley 32 being pulled up, the knees-linking member 22 is pulled upward, and the left knee harness 9L and the right knee harness 9R connected to the knees-linking member 22 are pulled upward. Then, a rearward acting force F2 is generated in each of the left knee harness 9L and the right knee harness 9R.

Consequently, a load on the back muscle, quadriceps, etc., of the wearer 61 having a stooped posture can be reduced, enabling effectively assisting a package lifting motion and a package lowering motion. Note that a load on the muscles in the waist region of the wearer 61 having a stooped posture can be reduced, enabling prevention of lower back pain.

Also, when a part of the knees-linking member 22, the part extending from the left knee harness 9L to the leg-side pulley 32 through the left guide portion 16L is pulled up, an acting force F3 of pushing the left hip region of the wearer forward is generated. Likewise, when a part of the knees-linking member 22, the part extending from the right knee harness 9R to the leg-side pulley 32 through the right guide portion 16R is pulled up, an acting force F3 of pushing the right hip region of the wearer forward is generated.

Note that disposing a guard panel P in an area, between the shoulder harness 3 and the waist harness 5, in which the wearer's body is not covered and the power transmission member 21 and the knees-linking member 22 are likely to come into contact with the body prevents the wearer and the power transmission member 21 and the knees-linking member 22 from coming into contact with each other and thus is more preferable.

Next, an input to and an output from the control unit 51 of the assist apparatus 1A will be described with reference to FIG. 5. As illustrated in FIG. 5, the control unit 51 received in the control box 35 includes, e.g., the control device (hereinafter referred to as “ECU”) 52 that controls the entirety of the assist apparatus 1A, and a motor driver 53. The power supply unit 38 supplies electric power to the ECU 52 and the motor driver 53 included in the control unit 51. The motor driver 53 is an electronic circuit that outputs a drive current for driving the electric motor 25A, based on a control signal from the ECU 52.

The ECU 52 includes, e.g., a CPU, a flash ROM (or an EEPROM), a RAM, a timer and a backup RAM. The CPU performs various arithmetic processing based on various programs and parameters stored in the Flash ROM (or the EEPROM). Also, the RANI temporarily stores, e.g., results of arithmetic operations in the CPU and data input from detection devices. The backup RAM stores, for example, data, etc., that should be stored, when the electric motor 25A is stopped.

An operation signal from the main switch 36A is input to the ECU 52. A rotational angle detection signal from the rotation detection means 25E that outputs a detection signal according to rotation of the electric motor 25A is input to the ECU 52. A detection signal according to inclinations in three directions, the X-axis, the Y-axis and the Z-axis, is input to the ECU 52 from each of the back triaxial acceleration and angular velocity sensor 41, the left-leg triaxial acceleration and angular velocity sensor 42L and the right-leg triaxial acceleration and angular velocity sensor 42R. Furthermore, an operation signal (press signal) is input to the ECU 52 from each of the lifting assist switch 36B and the lowering assist switch 36C provided at the control box 35.

Operation signals (press signals) from the ON switch 39A and the OFF switch 39B are input to the power supply unit 38. Upon an operation signal from the ON switch 39A being input, the power supply unit 38 supplies electric power to the ECU 52 and the motor driver 53. Upon an operation signal from the OFF switch 39B being input, the power supply unit 38 shuts off the supply of electric power to the ECU 52 and the motor driver 53.

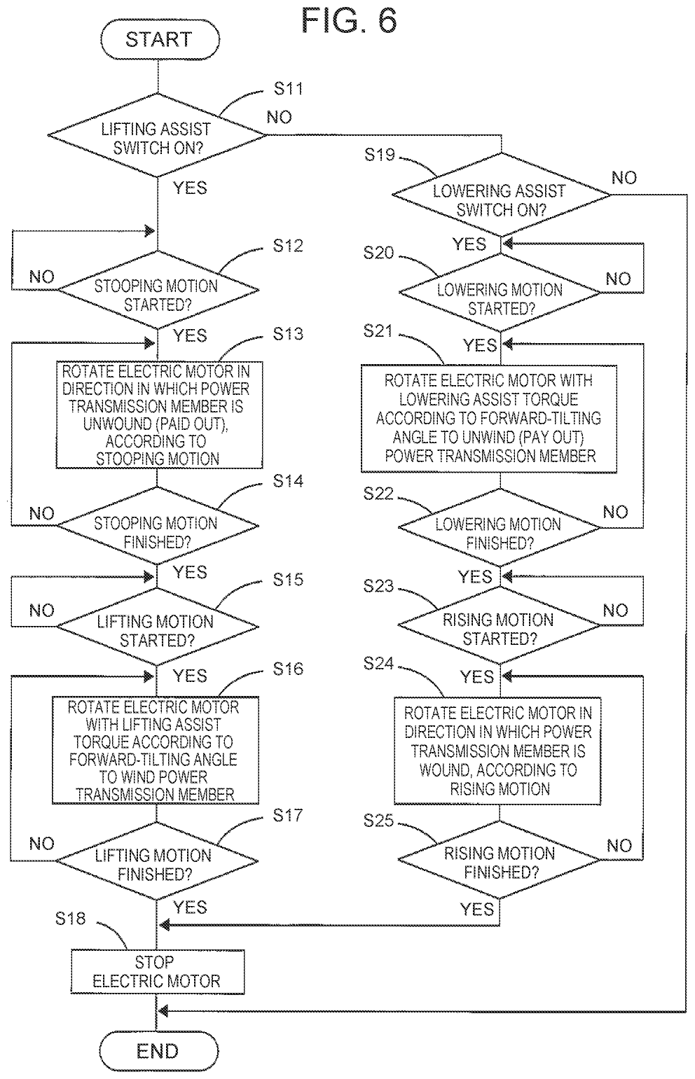

Next, assist processing performed by the ECU 52 of the assist apparatus 1A configured as described above will be described with reference to FIGS. 6 to 10. Note that the program indicated in the flowchart in FIG. 6 is stored in the flash ROM (or the EEPROM) of the ECU 52 and is executed by the ECU 52 every predetermined period of time (for example, every several milliseconds to several tens of milliseconds) upon the wearer turning the main switch 36A on. Upon the wearer turning the main switch 36A on, the ECU 52 advances the processing to step S11 illustrated in FIG. 6. The flowchart in FIG. 6 will be described below.

In step S11, the ECU 52 determines whether or not the lifting assist switch 36B has been pressed, that is, whether or not an ON signal has been input from the lifting assist switch 36B. Then, if it is determined that the lifting assist switch 36B has been pressed, that is, an ON signal has been input from the lifting assist switch 36B (Yes), the ECU 52 advances the processing to step S12, and if an ON signal has not been input from the lifting assist switch 36B (No), advances the processing to step S19.

If the ECU 52 advances the processing to step S12, the ECU 52 determines whether or not a stooping motion has started, and if it is determined that a stooping motion has started (Yes), advances the processing to step S13, and if it is determined that a stooping motion has not started (No), advances the processing to step S12.

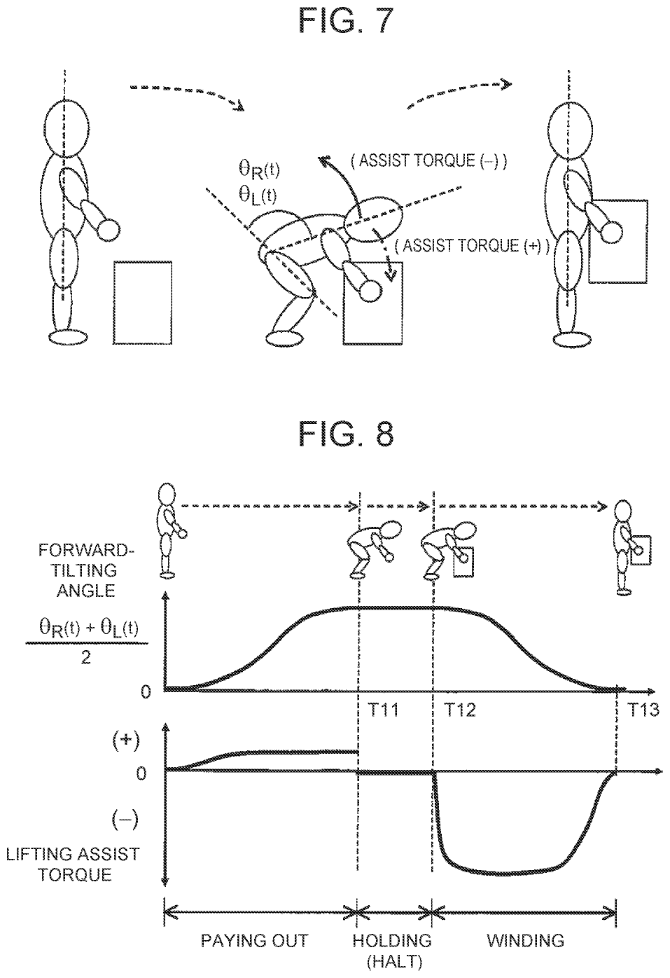

Here, a method of determining a start of a stooping motion will be described with reference to FIG. 7. As illustrated in FIG. 7, the ECU 52 (see FIG. 1) detects a forward-tilting angle θL(t) of the waist region relative to the left thigh region from detection signals of accelerations of the axes in the three directions, the X-axis, the Y-axis and Z-axis, input from the back triaxial acceleration and angular velocity sensor 41 and the left-leg triaxial acceleration and angular velocity sensor 42L and angular velocities of rotation around the respective axes and chronologically stores the forward-tilting angle θL(t) in the RAM. Also, the ECU 52 detects a forward-tilting angle θR(t) of the waist region relative to the right thigh region from detection signals of accelerations of the three directions axes, the X-axis, the Y-axis and the Z-axis, input from the back triaxial acceleration and angular velocity sensor 41 and the right-leg triaxial acceleration and angular velocity sensor 42R and angular velocities of rotation around the respective axes, and chronologically stores the forward-tilting angle θR(t) in the RAM.

Then, the ECU 52 calculates a forward-tilting angle θ(t) of the wearer according to Expression (1) below and chronologically stores the forward-tilting angle θ(t) in the RAM.

θ(t)=(θL(t)+θR(t))/2 (1)

Subsequently, the ECU 52 determines whether or not the forward-tilting angle θ(t) is not smaller than a first criterion angle θD1 (for example, approximately 5 degrees). Then, if it is determined that the forward-tilting angle θ(t) is not smaller than the first criterion angle θD1, the ECU 52 determines that the wearer has started a stooping motion (S12: Yes). On the other hand, if it is determined that the forward-tilting angle θ(t) is smaller than the first criterion angle θD1, the ECU 52 determines that the wearer has not yet started a stooping motion (S12: No). Note that the first criterion angle θD1 is stored in advance in the flash ROM (or the EEPROM). Also, the forward-tilting angle θ(t) when the wearer stands upright is “0 degrees”.

As illustrated in FIG. 6, if it is determined in step S12 that the wearer has not yet started a stooping motion (S12: No), the ECU 52 performs the processing in step S12 again and waits until the wearer starts a stooping motion. On the other hand, if it is determined in step S12 that the wearer has started a stooping motion (S12: Yes), the ECU 52 advances the processing to step S13.

In step S13, the ECU 52 calculates the forward-tilting angle θ(t) of the wearer from detection signals of accelerations and angular velocities input from the respective triaxial acceleration and angular velocity sensors 41, 42L, 42R, according to Expression (1) above. Then, the ECU 52 drives the electric motor 25A to rotate in a (reverse) rotation direction with a substantially-constant small stooping assist torque, based on the number of rotations detected by the rotation detection means 25E, according to the forward-tilting angle θ(t) of the wearer, that is, according to the stooping motion to unwind (pay out) the power transmission member 21 while adjusting an amount of the power transmission member 21 unwound, and advances the processing to step S14. Note that the small stooping assist torque is stored in advance in the flash ROM (or the EEPROM).

More specifically, as illustrated in FIGS. 7 and 8, the stooping assist torque is generated in the (reverse) rotation direction of the electric motor 25A, that is, a lowering direction so as not to hinder the stooping motion. Here, description will be provided on the premise that the sign of torque in the lowering direction is + (positive) and the sign of torque in a lifting direction is − (negative). Then, the ECU 52 advances the processing to step S14.

In step S14, the ECU 52 determines whether or not the stooping motion has finished, and if it is determined that the stooping motion has finished (Yes), advances the processing to step S15, and if it is determined that the stooping motion has not yet finished (No), returns the processing to step S13. More specifically, as illustrated in FIGS. 7 and 8, the ECU 52 determines whether or not an increase of the forward-tilting angle θ(t) of the wearer has substantially stopped. Then, if it is determined that the stooping motion has not finished, that is, if it is determined that the forward-tilting angle θ(t) is increasing (S14: No), the ECU 52 performs processing in step S13 onwards again.

On the other hand, if it is determined that the stooping motion has finished, that is, if it is determined that the forward-tilting angle θ(t) is not increasing (S14: Yes), the ECU 52 advances the processing to step S15. More specifically, as illustrated in FIG. 8, the wearer starts a stooping motion from an upright standing state at time 0, gradually increases the forward-tilting angle θ(t), and finishes the stooping motion at time T11.

If the ECU 52 advances the processing to step S15, the ECU 52 halts the electric motor 25A. Then, the ECU 52 determines whether or not the wearer has started a lifting motion, and if it is determined that the wearer has started a lifting motion (Yes), advances the processing to step S16, and if it is determined that the wearer has not started a lifting motion (No), performs the processing to step S15 again. More specifically, the ECU 52 calculates the forward-tilting angle θ(t) of the wearer from detection signals of accelerations and angular velocities input from the respective triaxial acceleration and angular velocity sensors 41, 42L, 42R, according to Expression (1) above. Subsequently, the ECU 52 determines whether or not the forward-tilting angle θ(t) has decreased by a second criterion angle θD2 (for example, approximately 3 degrees) or more.

Then, if it is determined that the forward-tilting angle θ(t) has decreased by the second criterion angle θD2 (for example, approximately 3 degrees) or more, the ECU 52 determines that the wearer has started a lifting motion (S15: Yes). On the other hand, if it is determined that the forward-tilting angle θ(t) has not decreased by the second criterion angle θD2 (for example, approximately 3 degrees) or more, the ECU 52 determines that the wearer has not started a lifting motion (S15: No).

Then, if it is determined that the wearer has not started a lifting motion (S15: No), the ECU 52 performs the processing in S15 again. On the other hand, if it is determined that the wearer has started a lifting motion (S15: Yes), the ECU 52 advances the processing to step S16.

When the ECU 52 advances the processing to step S16, the ECU 52 calculates the forward-tilting angle θ(t) of the wearer from detection signals of accelerations and angular velocities from the respective triaxial acceleration and angular velocity sensors 41, 42L, 42R, according to Expression (1) above.

Then, the ECU 52 drives the electric motor 25A to rotate in a (normal) rotation direction with a predetermined lifting assist torque, based on the number of rotations detected by the rotation detection means 25E, according to the forward-tilting angle θ(t) of the wearer, that is, according to the lifting motion to wind the power transmission member 21 while adjusting the amount of the power transmission member 21 wound, and advances the processing to step S17. Therefore, as illustrated in FIG. 8, the lifting assist torque is an assist torque in the lifting direction (− (negative) side in FIG. 8), enabling reduction of load on the waist region of the wearer and proper assistance of the lifting work. Note that the predetermined lifting assist torque is stored in advance in the flash ROM (or the EEPROM).

In step S17, the ECU 52 determines whether or not the lifting motion has finished, and if it is determined that the lifting motion has finished (Yes), advances the processing to step S18, and if it is determined that the lifting motion has not finished (No), advances the processing to step S16. More specifically, as illustrated in FIG. 8, after the wearer starts the lifting motion at time T12, the ECU 52 determines whether or not the forward-tilting angle θ(t) of the wearer has decreased to substantially “0 degrees”, that is, whether or not the wearer has entered an upright standing state. Then, if it is determined that the lifting motion has not finished, that is, if the forward-tilting angle θ(t) is decreasing (S17: No), the ECU 52 performs the processing in step S16 onwards again.

On the other hand, if it is determined that the lifting motion has finished, that is, if it is determined that the forward-tilting angle θ(t) has reached substantially “0 degrees” and the wearer has entered an upright standing state (S17: Yes), the ECU 52 advances the processing to step S18. More specifically, as illustrated in FIG. 8, the ECU 52 determines that the wearer has finished the lifting motion at time T13, and advances the processing to step S18.

In step S18, the ECU 52 stops electric motor 25A, and then, ends the processing illustrated in FIG. 6.

On the other hand, if it is determined in step S11 that the lifting assist switch 36B has not been pressed, that is, if it is determined that an ON signal has not been input from the lifting assist switch 36B (S11: No), the ECU 52 advances the processing to step S19.

If the processing advances to step S19, the ECU 52 determines whether or not the lowering assist switch 36C has been pressed, that is, whether or not an ON signal has been input from the lowering assist switch 36C. Then, if an ON signal has been input from the lowering assist switch 36C (Yes), the ECU 52 advances the processing to step S20, and if an ON signal has not been input from the lowering assist switch 36C (No), the ECU 52 ends the processing illustrated in FIG. 6. Then, if it is determined that the lowering assist switch 36C has been pressed, that is, an ON signal has been input from the lowering assist switch 36C (S19: Yes), the ECU 52 advances to step S20.

If the processing advances to step S20, the ECU 52 determines whether or not the wearer has started a lowering motion, and if it is determined that the wearer has started a lowering motion (Yes), advances the processing to step S21, and if it is determined that the wearer has not started a lowering motion (No), returns the processing back to step S20. More specifically, the ECU 52 calculates the forward-tilting angle θ(t) of the wearer from detection signals of accelerations and angular velocities input from the respective triaxial acceleration and angular velocity sensors 41, 42L, 42R, according to Expression (1) above. Then, the ECU 52 determines whether or not the forward-tilting angle θ(t) is not smaller than the first criterion angle θD1 (for example, approximately 5 degrees) or more.

Then, if it is determined that the forward-tilting angle θ(t) is smaller than the first criterion angle θD1, the ECU 52 determines that the wearer has not yet started a lowering motion (S20: No) and performs the processing in step S20 onwards again. On the other hand, if it is determined that the forward-tilting angle θ(t) is not smaller than the first criterion angle θD1, the ECU 52 determines that the wearer has started a lowering motion (S20: Yes) and advances the processing to step S21.

In step S21, the ECU 52 calculates the forward-tilting angle θ(t) of the wearer from detection signals of accelerations and angular velocities input from the respective triaxial acceleration and angular velocity sensors 41, 42L, 42R, according to Expression (1) above. Then, the ECU 52 drives the electric motor 25A to rotate in a (reverse) rotation direction with a predetermined lowering assist torque, based on the number of rotations detected by the rotation detection means 25E, according to the forward-tilting angle θ(t) of the wearer, that is, according to the lowering motion to unwind (pay out) the power transmission member 21 while adjusting the amount of the power transmission member 21 unwound, and advances the processing to step S22.

Therefore, as illustrated in FIG. 10, the lowering assist torque is an assist torque in the lifting direction (− (negative) side in FIG. 10), enabling reduction of load on the waist region of the wearer and proper assistance of the lowering work. Note that the predetermined lowering assist torque is stored in advance in the flash ROM (or the EEPROM).

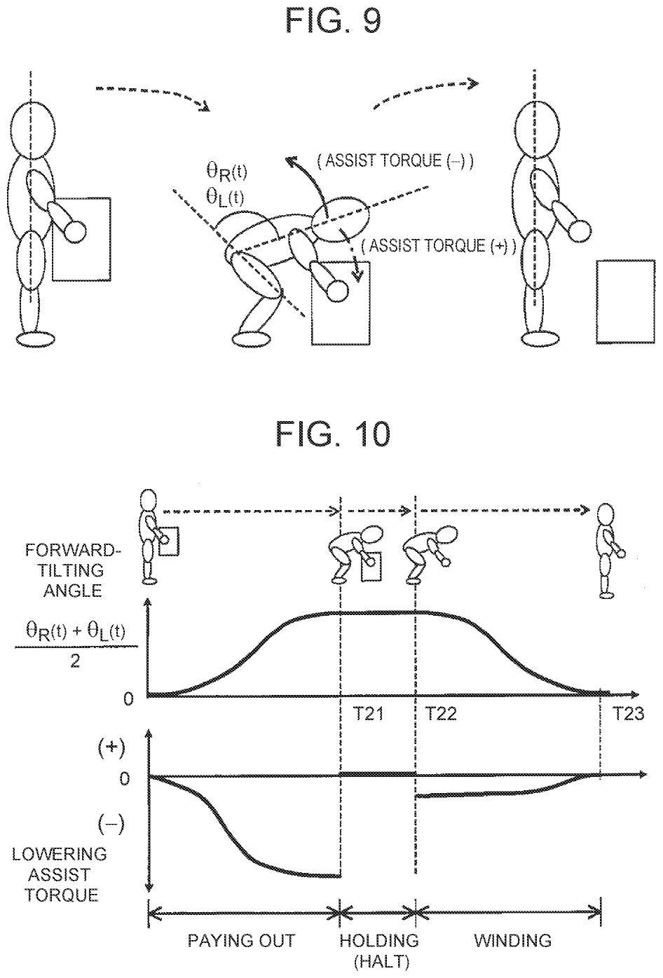

In step S22, the ECU 52 determines whether or not the lowering motion has finished, and if it is determined that the lowering motion has finished (Yes), advances the processing to step S23, and if it is determined that the lowering motion has not finished (No), returns the processing back to step S21. More specifically, as illustrated in FIGS. 9 and 10, the ECU 52 determines whether or not an increase of the forward-tilting angle θ(t) of the wearer has substantially stopped. Then, if it is determined that the lowering motion of the wearer has not finished, that is, if it is determined that the forward-tilting angle θ(t) is increasing (S22: No), the ECU 52 performs the processing in step S21 onwards again.

On the other hand, if it is determined that the lowering motion of the wearer has finished, that is, the forward-tilting angle θ(t) is not increasing (S22: Yes), the ECU 52 advances the processing to step S23. More specifically, as illustrated in FIG. 10, the wearer starts a lowering motion from an upright standing state at time 0, gradually increases the forward-tilting angle θ(t) and finishes the lowering motion at time T21.

If the processing advances to step S23, the ECU 52 halts the electric motor 25A. Then, the ECU 52 determines whether or not the wearer has started a rising motion, and if it is determined that the wearer has started a rising motion (Yes), advances the processing to step S24, and if it is determined that the wearer has not started a rising motion (No), returns the processing back to step S23. More specifically, the ECU 52 calculates the forward-tilting angle θ(t) of the wearer from detection signals of accelerations and angular velocities input from the respective triaxial acceleration and angular velocity sensors 41, 42L, 42R, according to Expression (1) above. Subsequently, the ECU 52 determines whether or not the forward-tilting angle θ(t) has decreased by the second criterion angle θD2 (for example, approximately 3 degrees) or more.

If it is determined that the forward-tilting angle θ(t) has decreased by the second criterion angle θD2 (for example, approximately 3 degrees) or more, the ECU 52 determines that the wearer has started a rising motion (S23: Yes). On the other hand, if it is determined that the forward-tilting angle θ(t) has not decreased by the second criterion angle θD2 (for example, approximately 3 degrees) or more, the ECU 52 determines that the wearer has not started a rising motion (S23: No).

Then, if it is determined that the wearer has not started a rising motion (S23: No), the ECU 52 performs the processing in S23 again. On the other hand, if it is determined that the wearer has started a rising motion (S23: Yes), the ECU 52 advances to step S24.

In step S24, the ECU 52 calculates the forward-tilting angle θ(t) of the wearer from detection signals of accelerations and angular velocities input from the respective triaxial acceleration and angular velocity sensors 41, 42L, 42R, according to Expression (1) above.

Then, the ECU 52 drives the electric motor 25A to rotate in a (normal) rotation direction with a predetermined rising assist torque, based on the number of rotations detected by the rotation detection means 25E, according to the forward-tilting angle θ(t) of the wearer, that is, according to the rising motion to wind the power transmission member 21 while adjusting the amount of the power transmission member 21 wound, and advances the processing to step S25. Therefore, as illustrated in FIG. 10, the lowering assist torque is an assist torque in the lifting direction (− (negative) side in FIG. 10), enabling reduction of load on the waist region of the wearer and proper assistance of the lowering work. Note that the predetermined rising assist torque is stored in advance in the flash ROM (or the EEPROM).

In step S25, the ECU 52 determines whether or not the rising motion has finished, and if it is determined that the rising motion has finished (Yes), advances the processing to step S18, and if it is determined that the rising motion has not finished (No), returns the processing back to step S24. More specifically, as illustrated in FIG. 10, after the wearer starts a rising motion at time T22, the ECU 52 determines whether or not the forward-tilting angle θ(t) of the wearer has decreased to substantially “0 degrees”, that is, whether or not the wearer has entered an upright standing state. Then, if it is determined that the rising motion has not finished, that is, if it is determined that the forward-tilting angle θ(t) is decreasing (S25: No), the ECU 52 performs the processing in step S24 onwards again.

On the other hand, if it is determined that the rising motion has finished, that is, if it is determined that the forward-tilting angle θ(t) has reached substantially “0 degrees” and the wearer has entered an upright standing state (S25: Yes), the ECU 52 advances the processing to step S18. More specifically, as illustrated in FIG. 10, the ECU 52 determines that the wearer has finished the rising motion at time T23 and advances the processing to step S18.

In step S18, the ECU 52 stops the electric motor 25A, and then, ends the processing illustrated in FIG. 6.

On the other hand, if it is determined in step S19 that the lowering assist switch 36C has not been pressed, that is, if it is determined that an ON signal has not been input from the lowering assist switch 36C (S19: No), the ECU 52 ends the processing illustrated in FIG. 6.

As described in detail above, in the assist apparatus 1A according to the present embodiment, as illustrated in FIGS. 1 to 4, the actuator 25 is disposed at a position within the region from the shoulder region to the waist region (shoulder harness 3 in the example in the present embodiment). Also, the power transmission member 21 is disposed so as to be connected to the motor pulley 25B and the transmission member length adjustment device 26 and sag down. The power transmission member 21 is looped around the back torso-side pulley 31, which is a moving pulley, and the knees-linking member 22 is looped around the leg-side pulley 32, which is a fixed pulley connected below the back torso-side pulley 31. Then, the left knee harness 9L is connected to the one end of the knees-linking member 22 and the right knee harness 9R is connected to the other end of the knees-linking member 22.

Then, the ECU (control device) 52 calculates a forward-tilting angle θ(t) of a wearer (information of a posture of the wearer) from detection signals of accelerations and angular velocities input from the respective triaxial acceleration and angular velocity sensors 41, 42L, 42R, according to Expression (1) above. Then, the ECU 52 controls driving of the electric motor 25A based on the forward-tilting angle θ(t) of the wearer to wind or unwind the power transmission member 21.

The shoulder harness 3, the waist harness 5, the left hip harness 7L, the right hip harness 7R, the left knee harness 9L and the right knee harness 9R included in the assist apparatus 1A are each formed of not a rigid component but, e.g., flexible fabric, enabling substantial reduction in weight and reduction of a burden in wearing. Also, use of a moving pulley for the back torso-side pulley 31 enables generation of a necessary assist force by a single relatively-small electric motor 25A and thus further reduction in weight.

Also, as illustrated in FIG. 4, an acting force F1 is generated on the back of a wearer having a forward-tilted posture, an acting force F2 is generated on each of the left knee and the right knee of the wearer and an acting force F3 is generated on each of the left hip region and the right hip region of the wearer, enabling reduction of load on the muscles of the wearer when having a forward-tilted posture, and thus enables effective assistance of a motion of lifting a package and a motion of lowering a package.

Furthermore, the electric motor 25A is connected to the motor pulley 25B with no gear provided therebetween, and thus there is no power transmission loss caused by a gear, enabling efficient assist force transmission.

The ECU (control device) 52 controls driving of the electric motor 25A based on rotation number information detected by the rotation detection means 25E to adjust a speed of winding or unwinding of the power transmission member 21. Consequently, the speed of winding or unwinding of the power transmission member 21 can be adjusted in accordance with the forward-tilted posture of the wearer, enabling effective assistance of a lifting motion and a lowering motion of the wearer.

The control box 35 that receives the control unit 51 and the power supply unit 38 that supplies electric power to the ECU (control device) 52 and the motor driver 53 are attached to the waist harness 5, enabling a wearer to freely move and perform work and thus enabling facilitation of work.

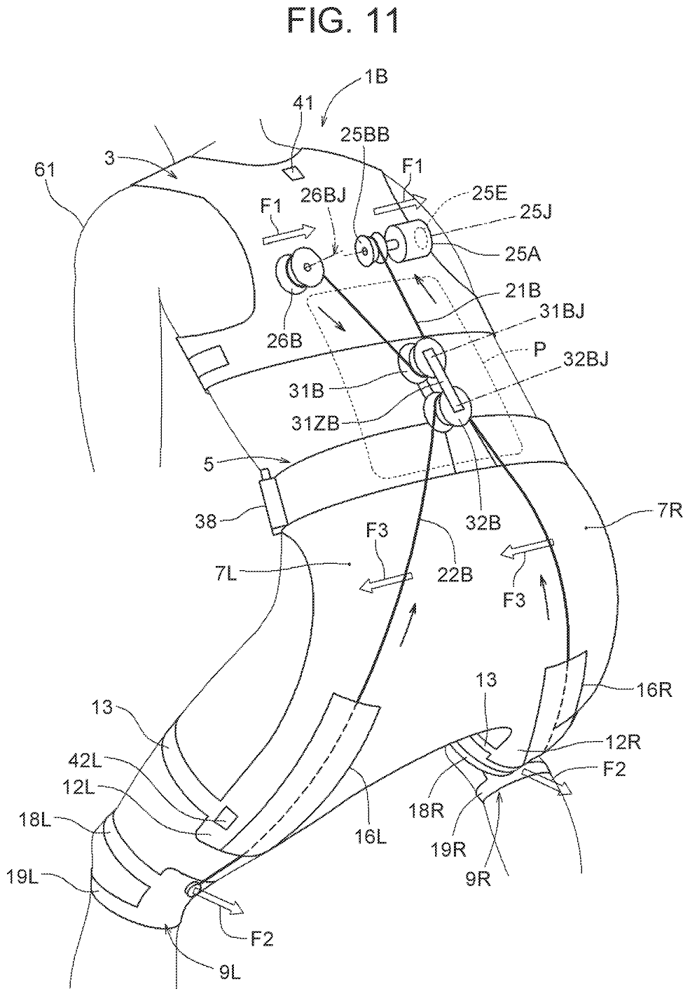

Next, a configuration of an assist apparatus 1B according to a second embodiment will be described with reference to FIG. 11. Note that assist operations and processing in an ECU (control device) are similar to those of the first embodiment and thus description thereof will be omitted.

As illustrated in FIG. 11, in comparison with the assist apparatus 1A according to the first embodiment illustrated in FIG. 4, in the assist apparatus 1B according to the second embodiment, the power transmission member 21 that is the first belt having the first predetermined width is changed to a power transmission member 21B that is a first cable having a first predetermined diameter and the knees-linking member 22 that is the second belt having the second predetermined width is changed to a knees-linking member 22B that is a second cable having a second predetermined diameter. Along with the changes, a length adjustment device rotation axis 26BJ, which is a rotation axis of a transmission member length adjustment device 26B, is set not in a right-left direction but in a front-rear direction of a wearer. Likewise, a back torso-side pulley rotation axis 31BJ of a back torso-side pulley 31B and a leg-side pulley rotation axis 32BJ of a leg-side pulley 32B are set not in the right-left direction but in the front-rear direction of the wearer. In addition, each of a motor pulley 25BB, the transmission member length adjustment device 26B, the back torso-side pulley 31B and the leg-side pulley 32B is not a substantially columnar pulley but a pulley including a V-groove. Also, the second embodiment is similar to the first embodiment in that the leg-side pulley 32B, which is a fixed pulley, is connected to the back torso-side pulley 31B, which is a moving pulley, via a pulley support portion 31ZB.

As a result of the above changes, the assist apparatus 1B according to the second embodiment is further lighter relative to the assist apparatus 1A according to the first embodiment (because of the change of the first belt and the second belt to the first cable and the second cable). Note that the power transmission member 21, the motor pulley 25B, the transmission member length adjustment device 26 and the back torso-side pulley 31 of the assist apparatus 1A according to the first embodiment illustrated in FIG. 4 may be changed to the power transmission member 21B, the motor pulley 25BB, the transmission member length adjustment device 26B and the back torso-side pulley 31B illustrated in FIG. 11 (it is possible that the power transmission member is the first cable and the knees-linking member is the second belt). Also, the knees-linking member 22 and the leg-side pulley 32 of the assist apparatus 1A according to the first embodiment illustrated in FIG. 4 may be changed to the knees-linking member 22B and the leg-side pulley 32B illustrated in FIG. 11 (it is possible that the power transmission member is the first belt and the knees-linking member is the second belt).

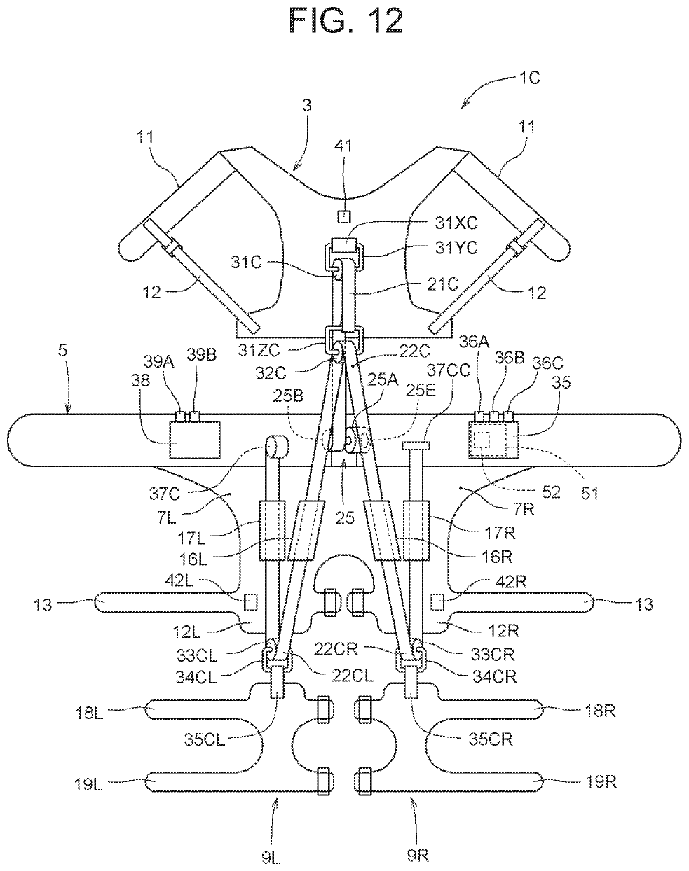

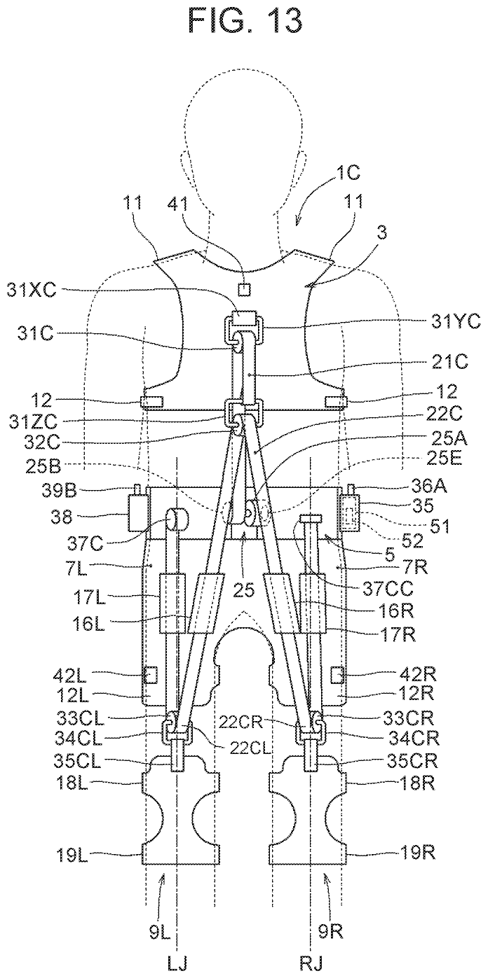

Next, a configuration of an assist apparatus 1C according to a third embodiment will be described with reference to FIGS. 12 to 15. Note that assist operations and processing in an ECU (control device) are similar to those of the first embodiment and thus description thereof will be omitted.

In the assist apparatus 1C according to the third embodiment illustrated in FIG. 12, a shoulder harness 3, a waist harness 5, a left hip harness 7L, a right hip harness 7R, a left knee harness 9L and a right knee harness 9R are the same in shape and material as those of the assist apparatus 1A according to the first embodiment illustrated in FIG. 1, and thus, description thereof will be omitted. Furthermore, a power supply unit 38, a control box 35, a back triaxial acceleration and angular velocity sensor 41, a left-leg triaxial acceleration and angular velocity sensor 42L and a right-leg triaxial acceleration and angular velocity sensor 42R are also the same as those of the assist apparatus 1A according to the first embodiment, and thus, description thereof will be omitted. The below description will be provided mainly on differences in configuration from the assist apparatus 1A according to the first embodiment illustrated in FIGS. 1 to 4.

An actuator 25 includes, e.g., an electric motor 25A and a motor pulley 25B. The actuator 25 is provided in the shoulder harness 3 or the waist harness 5; the present embodiment indicates an example in which the actuator 25 is provided in the waist harness 5. The motor pulley 25B is attached to the electric motor 25A. Another end of a power transmission member 21C is connected to the motor pulley 25B. Also, rotation detection means 25E is provided in the electric motor 25A. The rest of the electric motor 25A is similar to that of the electric motor according to the first embodiment, and thus, description thereof will be omitted. Note that as in the first embodiment, the actuator 25 does not necessarily need to be a winding device that performs winding and unwinding and may be an actuator that makes a linear motion.

The power transmission member 21C is a first belt having a first predetermined width or a first cable having a first predetermined diameter; the present embodiment indicates an example in which the power transmission member 21C is the first belt. The power transmission member 21C is a bendable elongated member made of, for example, fabric, and includes one end (or the other end) connected to a leg-side pulley 32C (pulley support portion 31ZC that supports the leg-side pulley 32C) and the other end (or the one end) connected to the motor pulley 25B. Note that either of the end portions of the power transmission member 21C may be “one end”. Also, the power transmission member 21C is looped around a back torso-side pulley 31C.

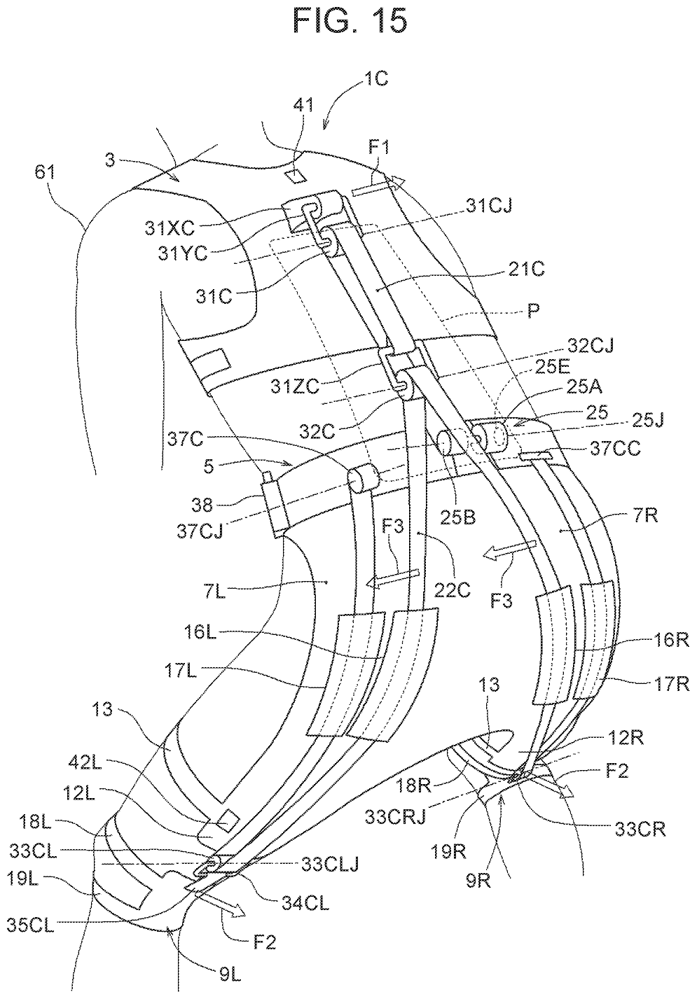

The back torso-side pulley 31C provided on a pulley support portion 31YC is a fixed pulley and is rotatably supported by a support 31XC attached to the shoulder harness 3, via a pulley support portion 31YC. Note that a diameter of the back torso-side pulley 31C is set to be a proper value as well as an assist target torque, an output torque of the electric motor 25A, a diameter of the motor pulley 25B, a diameter of the leg-side pulley 32C, a diameter of a left leg pulley 33CL and a diameter of a right leg pulley 33CR. Also, as illustrated in FIG. 15, a back torso-side pulley rotation axis 31CJ, which is a rotation axis of the back torso-side pulley 31C, (or a center axis (31CJ) of a part of a pulley support portion 31YC, the part corresponding to the back torso-side pulley 31C) is set in a right-left direction of a wearer. Consequently, even if the power transmission member 21C comes into contact with the wearer, the area of the contact between the wearer and the power transmission member 21C can be made larger in comparison with the case where the back torso-side pulley rotation axis 31CJ is set in a front-rear direction of the wearer. Note that the back torso-side pulley 31C may be omitted and a part of the pulley support portion 31YC, the part corresponding to the position of the back torso-side pulley 31C, may be replaced with a non-rotating columnar portion (columnar portion including a smooth outer circumferential surface and having a diameter corresponding to a diameter of the back torso-side pulley), and where the back torso-side pulley 31C is omitted, (the columnar portion of) the pulley support portion 31YC corresponds to the fixed pulley.

Then, the power transmission member 21C transmits (adjusts) power (a winding force, an unwinding force or a tensional force) of the actuator 25 to move the leg-side pulley 32C and the pulley support portion 31ZC upward or downward. In other words, the power of the actuator 25 is transmitted to the power transmission member 21C to move the leg-side pulley 32C and the pulley support portion 31ZC upward or downward. Then, the force of upward or downward movement transmitted to the leg-side pulley 32C (force between the back torso region and the leg region) acts on the leg side (knee region) via the knees-linking member 22C. Note that the power transmission member 21C does not necessarily need to be a belt. For example, the power transmission member 21C may be a linear member that moves upward and downward, the linear member supporting the rotation shaft portion (pulley support portion 31YC) of the leg-side pulley 32C so as to move the leg-side pulley 32C and the pulley support portion 31ZC upward and downward, being connected to an output of the actuator 25 and being formed of, e.g., flexible resin or metal (flexed according to the body shape of the wearer).

The leg-side pulley 32C is a pulley and is connected to the one end of the power transmission member 21C via the pulley support portion 31ZC. Also, the leg-side pulley 32C is provided below the back torso-side pulley 31C within the region from the shoulder region to the waist region of the wearer. Also, the knees-linking member 22C is looped around the leg-side pulley 32C. Also, a leg-side pulley rotation axis 32CJ, which is a rotation axis of the leg-side pulley 32C, is set in the right-left direction of the wearer. Consequently, even if the knees-linking member 22C comes into contact with the wearer, the area of the contact between the wearer and the knees-linking member 22C can be made larger in comparison with the case where the leg-side pulley rotation axis 32CJ is set in the front-rear direction of the wearer.

The knees-linking member 22C is a second belt having a second predetermined width or a second cable having a second predetermined diameter; the present embodiment indicates an example in which the knees-linking member 22C is the second belt. The knees-linking member 22C is a bendable elongated member made of, for example, fabric. The one end side of the knees-linking member 22C extends from the leg-side pulley 32C and is looped around the left leg pulley 33CL through a left guide portion 16L provided in the left hip harness 7L and connected to a linking member length adjustment device 37C through a left guide portion 17L. The other end side of the knees-linking member 22C extends from the leg-side pulley 32C and is looped around the right leg pulley 33CR through a right guide portion 16R provided in the right hip harness 7R and connected to a fixing portion 37CC of the waist harness 5 through a right guide portion 17R.

The left guide portion 17L guides the knees-linking member 22C from the linking member length adjustment device 37C toward the left leg pulley 33CL and the left guide portion 16L guides the knees-linking member 22C from the left leg pulley 33CL toward the leg-side pulley 32C. Likewise, the right guide portion 17R guides the knees-linking member 22C from the fixing portion 37CC toward the right leg pulley 33CR and the right guide portion 16R guides the knees-linking member 22C from the right leg pulley 33CR toward the leg-side pulley 32C.

The one end of the knees-linking member 22C is connected to a position in the waist harness 5, the position being within the region from the waist region to the hip region and being in the vicinity of a left leg center axis LJ of the wearer as the wearer is viewed from the back side, (is connected to that position via the linking member length adjustment device 37C). Also, the other end of the knees-linking member 22C is connected to a position in the waist harness 5, the position being within the region from the waist region to the hip region of the wearer and being in the vicinity of a right leg center axis RJ of the wearer as the wearer is viewed from the back side, (is connected to that position at the fixing portion 37CC). Consequently, an acting force F3, which is illustrated in FIG. 15, can more effectively be obtained.

The linking member length adjustment device 37C is provided in the waist harness 5 and the one end of the knees-linking member 22C is connected to the linking member length adjustment device 37C. The linking member length adjustment device 37C can be set in either one of a released state in which winding and unwinding of the connected knees-linking member 22C are possible and a locked state in which winding and unwinding of the connected knees-linking member 22C are prohibited, enables a length of the knees-linking member 22C (length of the W-shape from the left knee harness 9L to the right knee harness 9R) to be adjusted according to the physical size of the wearer and thus enables optimum (effective) transmission of an assist force. Also, a length adjustment device rotation axis 37CJ, which is a rotation axis of the linking member length adjustment device 37C, is set in a direction along a circumferential direction of the waist of the wearer. Note that the linking member length adjustment device 37C may be omitted and the one end of the knees-linking member 22C may be fixed to the waist harness 5.

The left leg pulley 33CL is a moving pulley, and a left linking member bend portion 22CL bent so as to sag down is looped around the left leg pulley 33CL between the one end (end portion connected to the linking member length adjustment device 37C) of the knees-linking member 22C and the leg-side pulley 32C. Also, a left leg pulley rotation axis 33CLJ, which is a rotation axis of the left leg pulley 33CL, is set in the right-left direction of the wearer. Consequently, even if the knees-linking member 22C comes into contact with the wearer, the area of the contact between the wearer and the knees-linking member 22C can be made larger in comparison with the case where the left leg pulley rotation axis 33CLJ is set in the front-rear direction of the wearer.

The right leg pulley 33CR is a moving pulley, and a right linking member bend portion 22CR bent so as to sag down is looped around the right leg pulley 33CR between the other end (end portion connected to the fixing portion 37CC) of the knees-linking member 22C and the leg-side pulley 32C. Also, a right leg pulley rotation axis 33CRJ, which is a rotation axis of the right leg pulley 33CR, is set in the right-left direction of the wearer. Consequently, even if the knees-linking member 22C comes into contact with the wearer, the area of contact between the wearer and the knees-linking member 22C can be made larger in comparison with the case where the right leg pulley rotation axis 33CRJ is set in the front-rear direction of the wearer.

Since each of the left leg pulley 33CL and the right leg pulley 33CR is a moving pulley, the output torque of the electric motor 25A may be half of a required torque, which is an assist force. Therefore, the electric motor 25A can be made smaller, enabling reduction in size and weight.

The left knee harness 9L and the left leg pulley 33CL are connected via a belt 35CL and a linking member 34CL. Note that a length of the belt 35CL is adjusted according to the physical size of the wearer.

The right knee harness 9R and the right leg pulley 33CR are connected via a belt 35CR and a linking member 34CR. Note that a length of the belt 35CR is adjusted according to the physical size of the wearer.

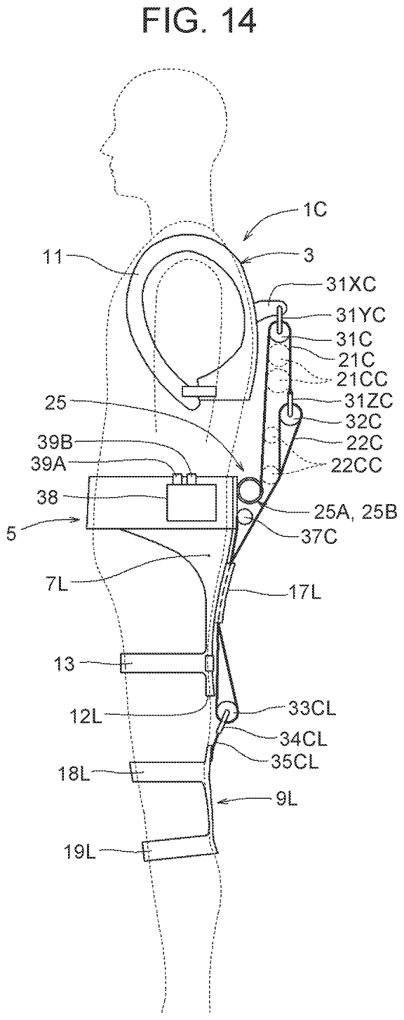

Also, as illustrated in FIG. 14, disposing rollers 21CC, 22CC below the back torso-side pulley 31C enables preventing the power transmission member 21C and the knees-linking member 22C from coming into contact with each other and thus is more preferable.

Also, disposing a guard panel P in an area, between the shoulder harness 3 and the waist harness 5, in which the wearer's body is not covered and the power transmission member 21C and the knees-linking member 22C are likely to come into contact with the body prevents the wearer and the power transmission member 21C and the knees-linking member 22C from coming into contact with each other and thus is more preferable.

In comparison with the assist apparatus 1A (see FIG. 4) according to the first embodiment, in the assist apparatus 1C (see FIG. 15) according to the third embodiment, the position at which the electric motor 25A is disposed is changed from the shoulder harness 3 to the waist harness 5, enabling making the back side of the shoulder harness 3 simple. For example, where the wearer of the assist apparatus is a caregiver, when a care-receiver puts his/her hand around the back of the caregiver from the shoulder, the hand of the care-receiver is less likely to come into contact with foreign objects (various pulleys, etc.), which is more preferable.

Since the one end side of the single knees-linking member 22C is looped around the left leg pulley 33CL connected to the left knee harness 9L and the other end side of the single knees-linking member 22C is looped around the right leg pulley 33CR connected to the right knee harness 9R, when the wearer walks, the wearer can easily walk. More specifically, during walking, when the wearer swings the right leg forward and the left leg rearward, the knees-linking member 22C is pulled up from the left leg side and is pulled out to the right leg side as viewed from the leg-side pulley 32C. When the wearer swings the right leg rearward and the left leg forward, the knees-linking member 22 is pulled up from the right leg side and pulled out to the left leg side as viewed from the leg-side pulley 32C. In other words, when the wearer walks, the knees-linking member 22C looped around the leg-side pulley 32C moves back and forth between the left leg side and the right leg side, and thus, the wearer can walk with almost no actuation of the actuator 25, and thus, the wearer can walk easily (in this case, the leg-side pulley 32C operates like a fixed pulley).

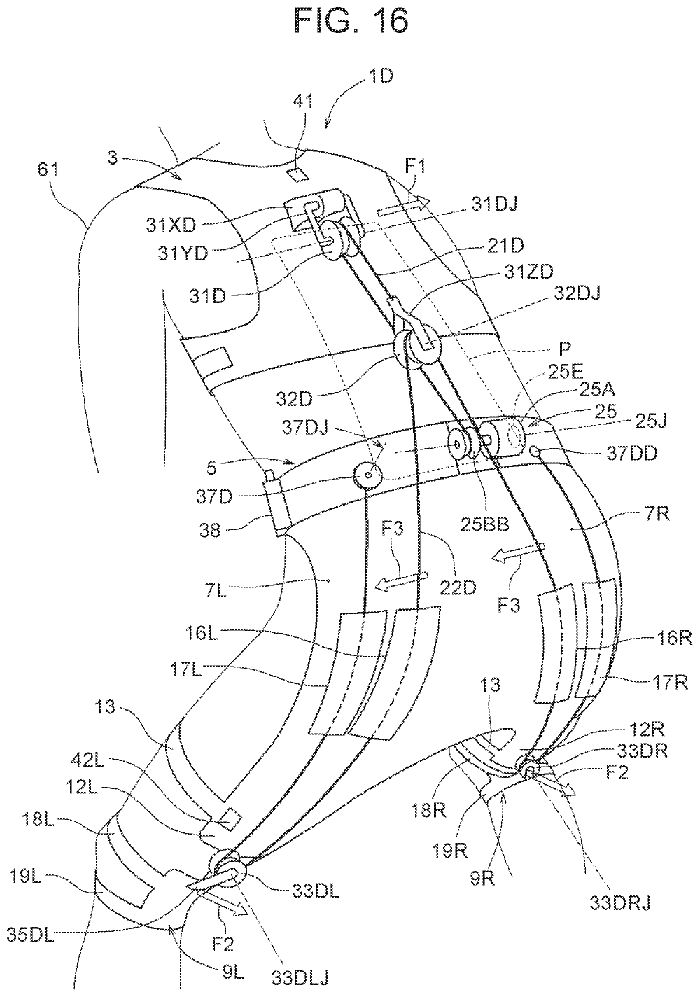

Next, a configuration of an assist apparatus 1D according to a fourth embodiment will be described with reference to FIG. 16. Note that assist operations and processing in an ECU (control device) are similar to those of the first embodiment and thus description thereof will be omitted.

As illustrated in FIG. 16, in comparison with the assist apparatus 1C according to the third embodiment illustrated in FIG. 15, in the assist apparatus 1D according to the fourth embodiment, the power transmission member 21C that is the first belt having the first predetermined width is changed to a power transmission member 21D that is a first cable having a first predetermined diameter and the knees-linking member 22C that is the second belt having the second predetermined width is changed to a knees-linking member 22D that is a second cable having a second predetermined diameter. Along with the changes, a length adjustment device rotation axis 37DJ, which is a rotation axis of a linking member length adjustment device 37D is set not in a circumferential direction of the waist region of the wearer but in a horizontal direction orthogonal to the circumferential direction. Likewise, a back torso-side pulley rotation axis 31DJ of a back torso-side pulley 31D, a leg-side pulley rotation axis 32DJ of a leg-side pulley 32D, a left leg pulley rotation axis 33DL) of a left leg pulley 33DL and a right leg pulley rotation axis 33DR) of a right leg pulley 33DR are set not in a right-left direction but in a front-rear direction of the wearer. In addition, each of the motor pulley 25BB, the linking member length adjustment device 37D, the back torso-side pulley 31D, the leg-side pulley 32D, the left leg pulley 33DL and the right leg pulley 33DR is not a substantially columnar pulley but a pulley including a V groove. Also, the fourth embodiment is similar to the third embodiment in that the leg-side pulley 32D, which is a fixed pulley, is connected to one end of the power transmission member 21D via a pulley support portion 31ZD. Also, a support 31XD, a pulley support portion 31YD, a fixing portion 37DD of the fourth embodiment (see FIG. 16) are similar to the support 31XC, the pulley support portion 31YC and the fixing portion 37CC of the third embodiment (see FIG. 15), respectively.

As a result of the above changes, the assist apparatus 1D according to the fourth embodiment is further lighter relative to the assist apparatus 1C according to the third embodiment (because of the change of the first belt and the second belt to the first cable and the second cable). Note that the power transmission member 21C, the motor pulley 25B and the back torso-side pulley 31C of the assist apparatus 1C according to the third embodiment illustrated in FIG. 15 may be changed to the power transmission member 21D, the motor pulley 25BB and the back torso-side pulley 31D illustrated in FIG. 16 (it is possible that the power transmission member is the first cable and the knees-linking member is the second belt). Also, the knees-linking member 22C, the leg-side pulley 32C and the linking member length adjustment device 37C of the assist apparatus 1C according to the third embodiment illustrated in FIG. 15 may be changed to the knees-linking member 22D, the leg-side pulley 32D and the linking member length adjustment device 37D illustrated in FIG. 16 (it is possible that the power transmission member is the first belt and the knees-linking member is the second belt).

It should be understood that the present disclosure is not limited to the above-described embodiments and various alterations, modifications, additions and deletions are possible without departing from the spirit of the present disclosure. Note that in the below description, reference numerals that are the same as those of components of the assist apparatus 1A according to the first embodiment illustrated in FIGS. 1 to 10 denote respective parts that are identical or correspond to the components or the like of the assist apparatus 1A according to the first embodiment.

For example, a lower edge portion of a shoulder harness 3 and an upper edge portion of a part of a waist harness 5, the part facing the back region, may be joined by a stretchable material such as mesh fabric. Also, respective lower edge portions of a left thigh fixing portion 12L and a right thigh fixing portion 12R of a left hip harness 7L and a right hip harness 7R and respective upper edge portions of a left knee harness 9L and a right knee harness 9R may be joined by a stretchable material such as mesh fabric. Consequently, the shoulder harness 3, the waist harness 5, the left hip harness 7L and the right hip harness 7R joined to the waist harness 5, the left knee harness 9L and the right knee harness 9R can be joined to one another and thus integrated, enabling enhancement in ease of handling the assist apparatuses 1A to 1D.

Also, for example, respective left guide portions 16L, 17L and respective right guide portions 16R, 17R of the left hip harness 7L and the right hip harness 7R are not limited to those having a tubular shape but may be configured by sewing a ring-like loop at each of a plurality of positions so as to allow a knees-linking member 22, 22B, 22C, 22D to be inserted therethrough. Consequently, the knees-linking member 22, 22B, 22C, 22D can smoothly be guided. Also, the left guide portion 16L, 17L and the right guide portion 16R, 17R may be omitted.

Also, for example, for each of the power transmission member 21, 21B, 21C, 21D and the knees-linking member 22, 22B, 22C, 22D, any of various components such as a string or a belt fabricated by resin or fiber and a cable made of metal may be used. Note that, e.g., carbon-containing fibers are favorable materials because of high tensile strength.

What is claimed is:

1. An assist apparatus comprising:
a shoulder harness to be fitted to right and left shoulder regions of a wearer;
an actuator provided in the shoulder harness;
a power transmission member connected to the actuator;
a pulley support portion that receives a force transmitted from the power transmission member, is to be disposed within a region from the shoulder regions to a waist region on a back side of the wearer, and supports a leg-side pulley, the leg-side pulley being a pulley to be disposed below the pulley support portion within the region from the shoulder regions to the waist region of the wearer;
a knees-linking member that is an elongated member looped around the leg-side pulley;
a left knee harness to be fitted to a left knee region of the wearer, the left knee harness being connected to a first end of the knees-linking member;
a right knee harness to be fitted to a right knee region of the wearer, the right knee harness being connected to a second end of the knees-linking member;
a posture detection device that detects a posture of the wearer; and
a control device that controls the actuator based on information of the posture of the wearer, the posture being detected by the posture detection device.

2. The assist apparatus according to claim 1, wherein:
a first end of the power transmission member is connected to the actuator; and
a second end of the power transmission member is connected to the shoulder harness via a length adjustment device, the length adjustment device is provided in the shoulder harness and is capable of being set to one of a released state and a locked state, and the released state is a state in which winding and unwinding of the power transmission member are possible and the locked state is a state in which winding and unwinding of the power transmission member are prohibited.

3. The assist apparatus according to claim 1 further comprising:
a left hip harness to be fitted to a left hip region of the wearer; and
a right hip harness to be fitted to a right hip region of the wearer, wherein
a left guide portion that enables the knees-linking member to be inserted through the left guide portion and guides the knees-linking member from the leg-side pulley toward the left knee harness is provided in the left hip harness; and
a right guide portion that enables the knees-linking member to be inserted through the right guide portion and guides the knees-linking member from the leg-side pulley toward the right knee harness is provided in the right hip harness.

4. The assist apparatus according to claim 1, wherein the power transmission member is either one of a first belt having a first predetermined width and a first cable having a first predetermined diameter, and the knees-linking member is either one of a second belt having a second predetermined width and a second cable having a second predetermined diameter.

5. The assist apparatus according to claim 1, wherein the knees-linking member is a second belt having a second predetermined width and a leg-side pulley rotation axis that is a rotation axis of the leg-side pulley is set in a right-left direction of the wearer.
